(19) United States
(12) Patent Application Publication
(10) Pub. No.: US 2011/0149171 A1
(43) Pub. Date: Jun. 23, 2011

(54) Efficient tuning and demodulation techniques

(76) Inventors: Nicholas P. Cowley, Wroughton (GB); Bernard Arambepola, Enfield (GB); Alan J. Martin, Plymouth (GB); Isaac Ali, Bristol (GB)

(21) Appl. No.: 12/653,795

(22) Filed: Dec. 21, 2009

(51) Int. Cl. H04N 5/50; H04B 1/66

(52) U.S. Cl. 348/731; 375/240.25; 348/E05.097; 375/E07.027

(57) ABSTRACT

Techniques for the reception and processing of wireless signals are disclosed. For instance, an apparatus may include multiple receiving paths, a content stream generation module, and a distribution module. The multiple receiving paths include a first receiving path that generates a first decoded signal from an input RF signal in accordance with a first tuning setting. The content stream generation module has first and second inputs. Based on decoded signals received at the first and second inputs, the content stream generation module may generate first and second content streams, respectively. In situations where both the first and second content streams correspond to the first tuning setting, the distribution module provides the first decoded signal to both the first and second inputs of the content stream generation module. Also, a control module may remove operational power from any of the plurality of receiving paths that are currently being unused.

### BACKGROUND

Within a particular location, such as a home, multiple devices are often concurrently used to receive multiple content streams (e.g., video streams). Examples of such devices include televisions, and digital video recorders (DVRs). For instance, while a DVR is recording certain television programs, a television may be simultaneously providing other content to a viewer.

A set-top box, may obtain the multiple content streams from a broadcast signal that is received over a wireless or wired medium. For instance, the set-top box may tune to particular portion(s) of the broadcast signal. From such tunings, the set top box obtains corresponding decoded signals. Each decoded signal may convey one or more content streams (e.g., one or more television stations). Thus, from these decoded signals, the set-top box may deliver individual content streams to each of multiple devices (e.g., televisions, DVRs, etc.).

For devices having such tuning capabilities, it is desirable to reduce interference between components within the device. Moreover, it is becoming increasingly desirable to provide devices that are relatively energy efficient. For instance, compliance with efficiency standards (such as Energy Star) is considered important to consumers when purchasing electronic devices.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an operational environment;

FIG. 2 is a diagram of an exemplary implementation;

FIG. 3 is a diagram showing a signal distribution;

FIG. 4 is a logic flow diagram; and

FIG. 5 is a diagram of an exemplary receiving path implementation.

### DETAILED DESCRIPTION

Embodiments provide techniques for the reception and processing of wireless signals. For instance, an apparatus may include multiple receiving paths, a content stream generation module, and a distribution module. The multiple receiving paths include a first receiving path that generates a first decoded signal from an input RF signal in accordance with a first tuning setting. The content stream generation module has first and second inputs. Based on decoded signals received at the first and second inputs, the content stream generation module may generate first and second content streams, respectively.

In situations where both the first and second content streams correspond to the first tuning setting, the distribution module provides the first decoded signal to both the first and second inputs of the content stream generation module.

The multiple receiving paths may further include a second receiving path that generates a second decoded signal from the input RF signal in accordance with a second tuning setting. In situations where the first content stream corresponds to the first tuning setting and the second content stream corresponds to the second tuning setting, the distribution module provides the first and second decoded signals to the first and second inputs of the content stream generation module, respectively.

Further embodiments may include a control module that removes operational power from any of the plurality of receiving paths that are currently being unused.

Thus, embodiments provide techniques that advantageously reduce power consumption in devices, such as network media platforms. Further, embodiments avoid two or more receiving paths being tuned to the same channel. As a result, interference between receiving paths may advantageously be reduced.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

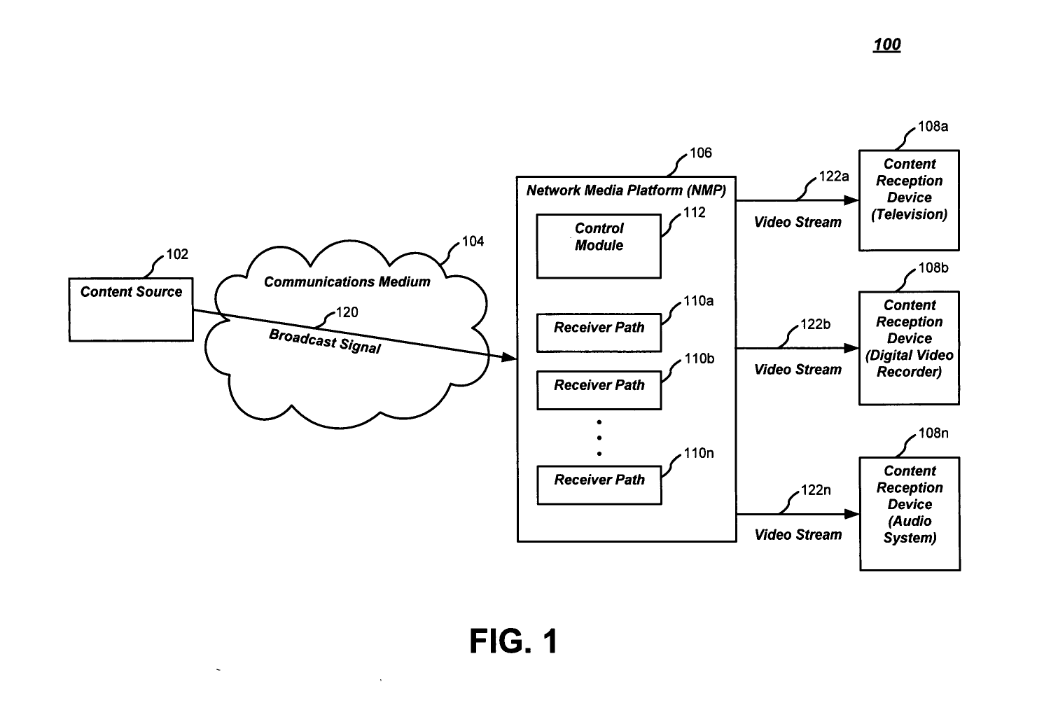

FIG. 1 is a diagram of an environment 100 in which the techniques described herein may be employed. This environment includes a content source 102, a communications medium 104, a network media platform (NMP) 106, and multiple content reception devices 108.

Content source 102 generates and transmits broadcast signal 120 across communications medium 104. Communications medium 104 may be wireless. For instance, communications medium 104 may include a terrestrial broadcast medium or a satellite broadcast medium. Alternatively, communications medium 104 may be wired, such as a co-axial cable. Embodiments, however, are not limited to these examples.

In embodiments, broadcast signal 120 is a digital video signal. Exemplary digital video signals include digital video broadcasting (DVB) signals, such as DVB terrestrial (DVB-T) signals, and digital multimedia broadcast-terrestrial/handheld (DMB-T/H). Further examples of digital video signals include Data Over Cable Service Interface Specification (DOCSIS) signals. Embodiments, however, are not limited to such signals. Moreover, embodiments are not limited to contexts involving video signals.

Thus, content source 102 may include a DVB source node, a satellite earth station, a satellite, a cable headend, and/or other entities. In embodiments, content source 102 may be implemented with one or more components (e.g., encoders, modulators, amplifiers, antennas, and so forth) that generate broadcast signal 120 from live and/or recorded content.

In embodiments, broadcast signal 120 comprises multiple channels (e.g., multiple frequency channels). Each of these channels is modulated (e.g., as a complex spectrum). This modulation may be in accordance with various schemes. Exemplary schemes include (but are not limited to) orthogonal frequency division multiplexing (OFDM), phase shift keying (PSK), and frequency shift keying (FSK).

The channels within broadcast signal 120 may convey multiple streams of data. For instance, each channel may provide a transport stream (e.g., an MPEG transport stream) comprising multiple elementary streams of content. For example, in the case of DOCSIS systems, a channel within broadcast signal 120 may convey up to 10 independent television stations.

As shown in FIG. 1, NMP 106 may generate multiple content streams from broadcast signal 120. For instance, FIG. 1 shows NMP 106 providing a video stream 122a to a television 108a, a video stream 122b to a digital video recorder (DVR) 108b, and a video stream 122n to a television 108n. In turn, these devices perform particular operations on their corresponding content streams. For instance, television 108a outputs video stream 122a to a user, DVR 108b records video stream 122b for subsequent viewing, and television 108n outputs video stream 122n to a user.

The generation of content streams 122a-n involves NMP 106 first producing one or more decoded signals (not shown) from broadcast signal 120, and then generating content streams 122a-n from the decoded signal(s). To generate the decoded signals, NMP 106 includes multiple receiving paths. Each of these paths may be individually tuned to channels within broadcast signal 120.

During operation, situations may arise when NMP 106 outputs multiple content streams (e.g., two or more of streams 122a-n) that are associated with the same channel within broadcast signal 120. In such situations, conventional NMP arrangements will tune two or more of its corresponding receiving paths to the same channel. However, various drawbacks are associated with this approach. For instance, this approach consumes excessive energy by providing operational power to the two or more receiving paths. Moreover, by employing the same tunings, the two or more receiving paths may interfere with each other.

Embodiments overcome such drawbacks. For example, in such situations, NMP 106 recognizes a request (e.g., based on a user's content selection) for a currently employed channel tuning. In response, NMP 106 employs a multiplexing operation. This operation distributes a decoded signal from an individual receiving path so that multiple content streams can be produced from it. Furthermore, this operation may allow for a receiving path to be depowered because it is not currently needed to produce a decoded signal.

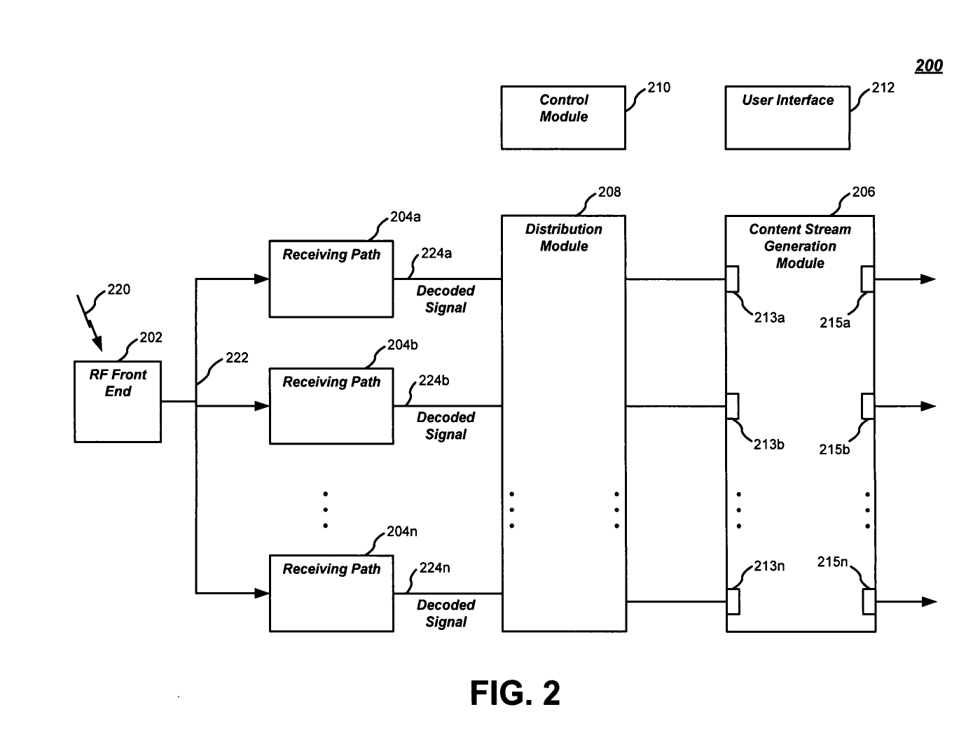

FIG. 2 is a diagram showing an implementation 200, which may be included in NMP 106. However, implementation 200 is not limited to the context of FIG. 1. Moreover, this implementation may be employed in contexts other than ones involving video signals.

Implementation 200 may include various elements. For instance, FIG. 2 shows implementation 200 including a radio frequency (RF) front end 202, a plurality of receiving paths 204a-n, a content stream generation module 206, a distribution module 208, a control module 210, and a user interface 212. These elements may be implemented in any combination of hardware and/or software.

RF front end 202 receives an RF signal 220. In the context of FIG. 1, signal 220 may be RF signal 120 received from communications medium 104. In turn, RF front end 202 produces an analog signal 222, which is sent to receiving paths 204a-n. This generation of analog signal 222 from RF signal 220 may involve various operations, such as amplification and filtering. Accordingly, RF front end 202 may include electronic components (e.g., circuitry), such as any combination of antennas, amplifiers, filters, and so forth.

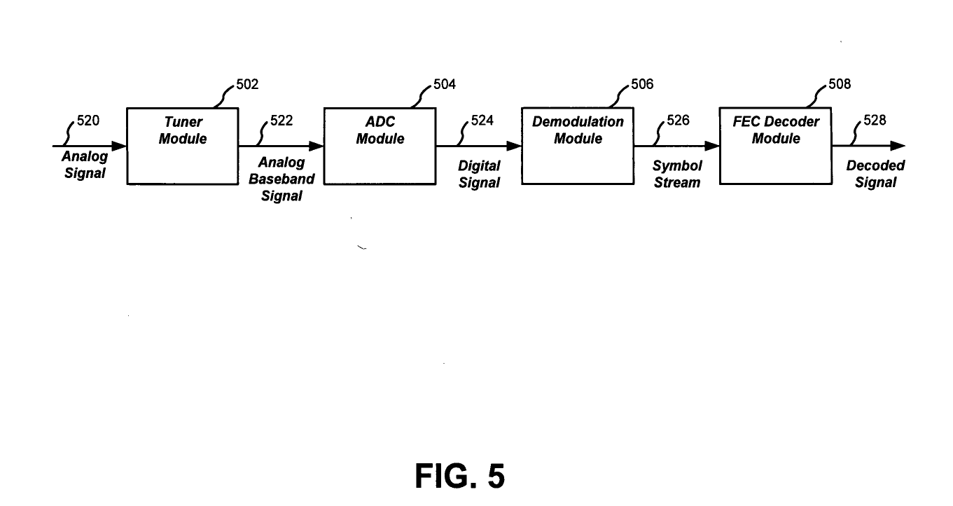

FIG. 2 shows that signal 222 is received by receiving paths 204a-n. In turn, each of these paths may employ a tuning to generate a corresponding decoded signal. For purposes of illustration, FIG. 2 shows receiving paths 204a-n generating decoded signals 224a-n, respectively. The generation of such decoded signals may involve various operations. Such operations may include (but are not limited to) analog to digital conversion, demodulation, and decoding operations. An exemplary receiving path implementation is described below with reference to FIG. 5.

Operational characteristics for each of receiving paths 204a-n may be independently adjusted. For instance, each of these paths may be independently tuned. Also, operational power may be selectively applied to (and removed from) each of these paths. In embodiments, adjustments of such operational characteristics are controlled by control module 210.

Each of decoded signals 224a-n corresponds to a channel within RF signal 220 (based on the corresponding receiving path's tuning). As described above, multiple streams of data may be conveyed in each of decoded signals 224a-n. For instance, a decoded signal may provide a transport stream (e.g., an MPEG transport stream) comprising multiple elementary streams of content, or a cable system channel (e.g., a DOCSIS channel) conveying multiple independent television content streams. Embodiments, however, are not limited to these examples.

Content stream generation module 206 generates content streams from decoded signals. As shown in FIG. 2, content stream generation module 206 includes multiple input ports 213a-n that receive decoded signals from distribution module 208. In addition content stream generation module 206 includes multiple output ports 215a-n that correspond to input ports 213a-n, respectively.

Accordingly, content stream generation module 206 may produce one or more content streams at output ports 215a-n based on one or more corresponding decoded signals received at input ports 213a-n, respectively. This production of content stream(s) may involve various operations, such as establishing synchronization with the corresponding decoded signal(s), and separating desired content from other information within the decoded signal(s).

As described above, situations may arise when multiple content streams are associated with the same channel tuning of a broadcast signal. Thus, content stream generation module 206 may generate multiple content streams (i.e., at two or more of output ports 215a-n) that are derived from the same tuning of RF signal 220.

Conventionally, when this situation arises, multiple receiving paths generate distinct decoded signals for each of the multiple content streams. Consequently, the multiple receiving paths employ the same tunings. As indicated above, this conventional approach may unfortunately consume excessive energy and may cause interference between receiving paths.

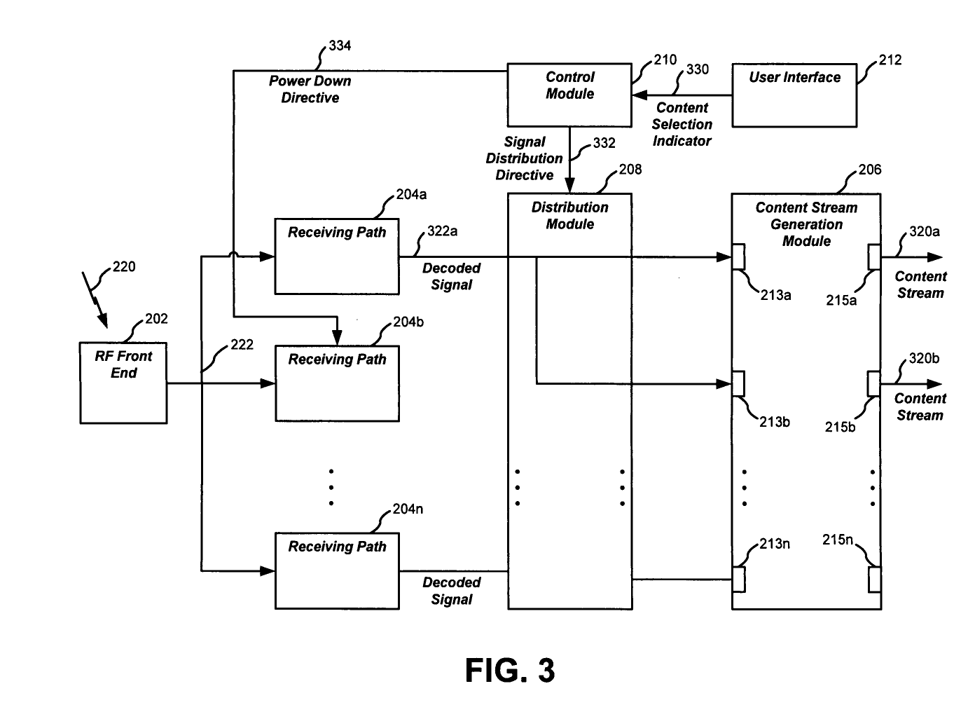

Embodiments overcome these shortcomings through the employment of distribution module 208. For instance, distribution module 208 distributes decoded signals from one or more of receiving paths 204a-n to avoid multiple receiving paths having the same tuning. An example of this feature is provided below with reference to FIG. 3.

Thus, distribution module 208 operates as an intermediary between receiving paths 204a-n and content stream generation module 206. More particularly, distribution module 214 may provide a particular decoded signal to multiple input ports of content stream generation module 206.

Control module 210 manages various operations of implementation 200. As described above, control module 210 controls tunings and power settings of receiving paths 204a-n. In addition, control module 210 establishes signal distribution mappings employed by distribution module 208.

For instance, control module 210 may receive a content selection for one of output ports 215a-n. In embodiments, this selection may be from user interface 212. In response to this selection, control module 210 identifies a tuning that corresponds to this content selection. Based on this identification, control module 210 then determines whether any of receiving paths 204a-n are currently employing this tuning. If so, then control module 210 directs distribution module 208 to route the decoded signal produced by this receiving path to the appropriate input port 213 of content stream generation module 206.

However, if control module 210 determines that none of receiving paths 204a-n is employing the appropriate tuning, then control module 210 directs a receiving path (e.g., a currently unutilized receiving path) to employ this tuning. In addition, control module 210 directs distribution module 208 to route the decoded signal produced by this receiving path to the appropriate input port 213 of content stream generation module 206.

Further, control module 210 may selectively apply and remove operational power to each of receiving paths 204a-n. For example, control module 210 may remove operational power from those of receiving paths 204a-n that are not currently being used. Similarly, control module 210 may apply power to individual receiving paths when they are needed to provide a decoded signal (e.g., in response to a content selection).

As described above, control module 210 performs various operations based on content selections (e.g., by a user). In embodiments, such content selections are made through user interface 212. User interface 212 exchanges information with a user. For instance, user interface 212 may receive content selections from a user. In the context of video content, such selections may include (but are not limited to) television station selections. Additionally or alternatively, user interface 212 may exchange such content selection information with other devices (e.g., content output devices). Such exchanges with other devices may be through wired and/or wireless media.

FIG. 3 is a diagram showing an exemplary signal distribution employed in the context of implementation 200. In particular, FIG. 3 shows control module 210 receiving a content selection indicator 330 from user interface 212. This indicator identifies a content stream selection for output port 215b. Upon receipt of this indicator, control module 210 determines that the content stream selection corresponds to a tuning currently employed by receiving path 204a.

Accordingly, control module 210 issues a signal distribution directive 332 to distribution module 208. This directive instructs distribution module 208 to distribute a decoded signal 322a (which is produced by receiving path 204a) to both input ports 213a and 213b. As a result, content stream generation module 206 outputs a first content stream 320a at output port 215a, and a second content stream 320b at output port 215b. Content streams 320a and 320b both derive from the same tuning of RF signal 220.

In addition, FIG. 3 shows control module 210 sending a power down directive 334 to receiving path 204b. In response to this directive, operational power to receiving path 204b is removed. As a result, savings in energy consumption may be advantageously achieved.

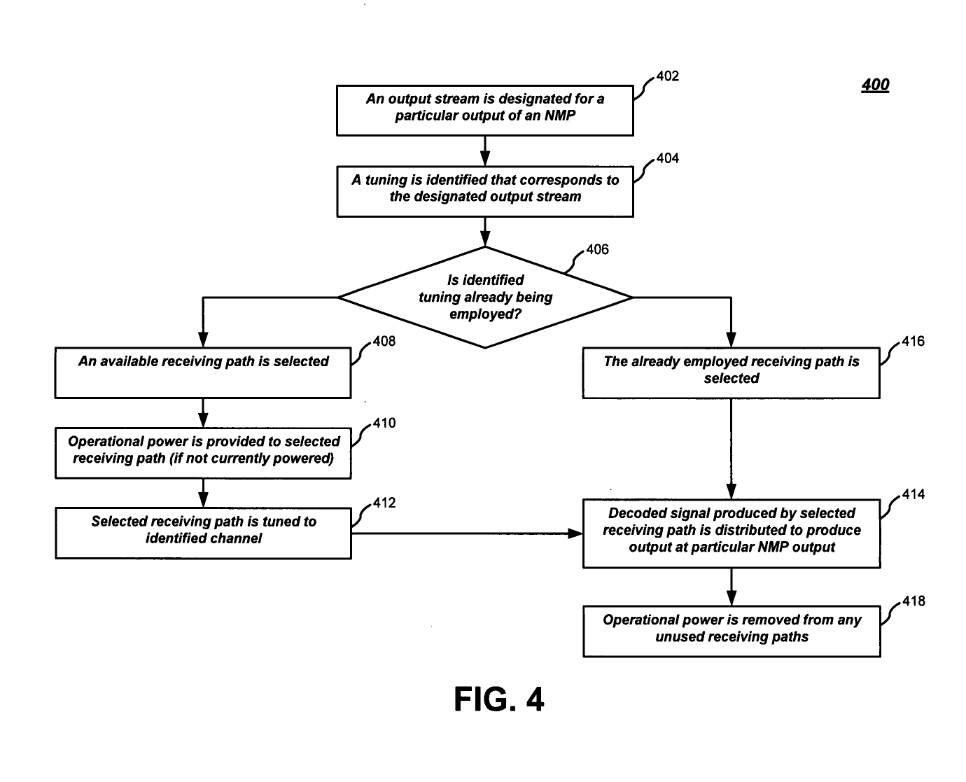

FIG. 4 illustrates an embodiment of a logic flow. In particular, FIG. 4 illustrates a logic flow 400, which may be representative of the operations executed by one or more embodiments described herein. Although FIG. 4 shows a particular sequence, other sequences may be employed. Also, the depicted operations may be performed in various parallel and/or sequential combinations. Further, these operations may be performed within a NMP implementation, such as the implementation of FIG. 2. Embodiments, however, are not limited to this context.

At a block 402, an output content stream is designated for a particular output of a NMP (e.g., NMP 106). This designation may be, for example, a cable television station, a DVB television station, a particular elementary stream within a transport stream (e.g., within an MPEG transport stream), or other content type. Thus, embodiments are not limited to these examples.

In embodiments, this designation may be based on a user selection. For example, in the context of FIG. 2 such user selections may be made through user interface 212. Additionally or alternatively, such selections may be made through user interfaces of other devices. Also, in the context of FIG. 2, such selections may indicate a particular output port 215.

At a block 404, a corresponding channel tuning is identified based on the designated output stream. With reference to FIG. 2, this may involve control module 210 determining a tuning for a receiving path.

Following this, it is determined (at a block 406) whether the identified channel tuning is already being employed by a receiving path. If not, then a block 408 is performed where an available (e.g., currently unused) receiving path is selected. At a block 410, the operational power is provided to the selected receiving path (if it is currently not powered). Following this, the receiving path is tuned to the identified channel at a block 412. Further, at a block 414, the decoded signal produced by this identified receiving path is distributed within the NMP so that it can produce the selected content at the particular output port.

However, if the identified channel tuning is already being employed by a receiving path, then operation proceeds from block 406 to a block 416. At this block, this receiving path is selected. Following this, operation proceeds to block 414, where the decoded signal produced by the identified receiving path is distributed within the NMP so that it can produce the selected content at the particular output port.

Further, at a block 418, any receiving paths that are not contributing to the output of content streams by the NMP (also referred to as unused receiving paths) are depowered.

FIG. 5 is a diagram of an implementation 500 that may be included in a receiving path (e.g., one or more of receiving paths 204a-n). This implementation includes a tuner module 502, an analog to digital converter module 504, a demodulator module 506, and a forward error correction (FEC) decoder module 508. These elements may be implemented in any combination of hardware and software.

As shown in FIG. 5, tuner module 502 receives an analog signal 520, which may correspond to a broadcast signal, such as broadcast signal 120 of FIG. 1. Tuner module 502 is “tuned” to receive a portion of analog signal 520 (e.g., a contiguous frequency channel or band) and produce a corresponding analog baseband signal 522. In embodiments, this may involve filtering and/or downconversion operations. As described above, operational characteristics of tuning module 502 may be adjustable (e.g., in response to directives from control module 210 of FIG. 2).

FIG. 5 shows that ADC module 504 receives analog baseband 522 signal. In turn, ADC module 504 produces a corresponding digital signal 524, which is sent to demodulator module 506. Demodulator module 506 demodulates digital signal 524 to produce a corresponding symbol stream 526. As described herein, this demodulation may be in accordance with various modulation schemes, such as OFDM, PSK, and/or FSK.

FEC decoder module 508 decodes symbol stream 526, which produces a corresponding decoded signal 528. This decoding may be in accordance with various techniques, such as any combination of block encoding and/or convolutional encoding schemes.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASICs), programmable logic devices (PLDs), digital signal processors (DSPs), field programmable gate array (FPGA), logic gates, registers, semiconductor device, chips, microchips, chip sets, and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing module, computing module, computing device, processing device, computing system, processing system, computer, processor, or the like, and may be implemented using any suitable combination of hardware and/or software.

The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While various embodiments of the present invention have been described above, it should be understood that they have been presented by way of example only, and not in limitation. For instance, the techniques discussed herein are not limited to the reception and processing of DVB-T and DMB-T/H signals. Thus, embodiments are not limited to these signals. Also, embodiments may employ signals other than OFDM signals (e.g., single carrier signals). Moreover, embodiments are not limited to digital video implementations.

Further, the techniques described herein may be employed with next generation digital television standards, such as DVB-T2, which is currently under development. DVB-T2 provides features (e.g., multiple-input multiple-output (MIMO), multiple-input single-output (MISO), low-density parity-check code (LDPC), and so forth). The implementation features and allocations between hardware modules that are described herein may be employed for such next generation digital television standards.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An apparatus, comprising:
a plurality of receiving paths, including a first receiving path that generates a first decoded signal from an input RF signal in accordance with a first tuning setting;
a content stream generation module having a first input and a second input, the content stream generation module to generate first and second content streams based on decoded signals received at the first and second inputs, respectively; and
a distribution module to provide the first decoded signal to both the first and second inputs of the content stream generation module when both the first and second content streams correspond to the first tuning setting.

2. The apparatus of claim 1:
wherein the plurality of receiving paths includes a second receiving path to generate a second decoded signal from the input RF signal in accordance with a second tuning setting; and
wherein, when the first content stream corresponds to the first tuning setting and the second content stream corresponds to the second tuning setting, the distribution module is to provide the first and second decoded signals to the first and second inputs of the content stream generation module, respectively.

3. The apparatus of claim 2, further comprising a control module;
wherein the control module is to remove operational power from any of the plurality of receiving paths that are currently being unused.

4. The apparatus of claim 2, wherein each of the plurality of receiving paths includes:
a tuner module to generate an analog baseband signal from the input RF signal; and
a demodulation module to produce a symbol stream from the analog baseband signal.

5. The apparatus of claim 4, wherein each of the plurality of receiving paths further includes:
a forward error correction (FEC) decoder module to produce a decoded signal from the symbol stream.

6. The apparatus of claim 1, wherein the first decoded signal conveys a plurality of content streams.

7. The apparatus of claim 1, wherein the first decoded signal comprises a Moving Pictures Expert Group (MPEG) transport stream.

8. A method, comprising:
determining a tuning for an output stream designation;
identifying one of a plurality of receiving paths in a network media platform (NMP) that is already employing the tuning; and
distributing a decoded signal produced by said one receiving path within the NMP

9. The method of claim 8, wherein said distributing the decoded signal comprises sending the decoded signal to two or more input ports of a content stream generation module.

10. The method of claim 9, further comprising:
outputting, by the content stream generation module, first and second content streams;
wherein each of the first and second content streams correspond to the decoded signal.

11. The method of claim 8, wherein the decoded signal comprises conveys multiple content streams.

12. The method of claim 8, wherein the decoded signal is a moving pictures expert group (MPEG) transport stream.

13. The method of claim 8, wherein the output stream designation is based on a user selection.

14. The method of claim 13, further comprising:
receiving the user selection at a user interface.

15. The method of claim 8, further comprising:
receiving an input RF signal; and
generating the decoded signal from the input RF signal.

16. The method of claim 15, wherein generating the decoded signal from the input RF signal comprises:
generating an analog baseband signal from the input RF signal; and
demodulating the analog baseband signal into a symbol stream.

17. The method of claim 16, wherein generating the decoded signal from the input RF signal further comprises:
decoding the symbol stream in accordance with a forward error correction (FEC) decoding scheme.

18. An article comprising a machine-accessible medium having stored thereon instructions that, when executed by a machine, cause the machine to:
determine a tuning for an output stream designation;
identify one of a plurality of receiving paths in a network media platform (NMP) that is already employing the tuning; and
distribute a decoded signal produced by said one receiving path within the NMP

19. The article of claim 18, wherein said instructions that cause the machine to distribute the decoded signal comprises instructions that cause the machine to:
send the decoded signal to two or more input ports of a content stream generation module.

20. The article of claim 19, further comprising instructions that cause the machine to:
output, by the content stream generation module, first and second content streams;
wherein each of the first and second content streams correspond to the decoded signal.
